(19) United States
(12) Patent Application Publication
(10) Pub. No.: US 2006/0043714 A1
(43) Pub. Date: Mar. 2, 2006

(54) Apparatus for providing inflator thrust neutrality

(75) Inventors: Vincent J. Mramor, Chandler, AZ (US); James A. Myers, Gilbert, AZ (US); Halley O. Stevens, Mesa, AZ (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/930,476

(22) Filed: Aug. 31, 2004

(51) Int. Cl. B60R 21/26

(52) U.S. Cl. 280/736

(57) ABSTRACT

An apparatus (12) includes an inflator (50) that is actuatable for providing inflation fluid. First structure (110) that is associated with the inflator (50) includes a plurality of first flow passages (150) that are sized and positioned relative to one another so as to provide thrust neutrality to the apparatus (10) when inflation fluid exits the apparatus (12) through the first flow passages (150) in a first condition of the inflator (50). The apparatus (10) also includes second structure (162) that is associated with the inflator (50). The second structure (162) blocks fluid flow through the first flow passages (150) and provides fluid flow through a second passage (172) in a second condition of the inflator (50).

### TECHNICAL FIELD

The present invention relates to an apparatus for providing inflation fluid and, more particularly, relates to an apparatus for providing inflation fluid to an inflatable vehicle occupant protection device.

### BACKGROUND OF THE INVENTION

Inflators for providing inflation fluid to an inflatable vehicle occupant protection device often include a container having a chamber in which a fluid under pressure is stored. A rupturable burst disk closes an exit opening of the chamber. An initiator is associated with the inflator and is actuatable for rupturing the burst disk to enable inflation fluid to exit the chamber through the exit opening. It is also common for an inflator to include an autoignition mechanism. The autoignition mechanism actuates the inflator when the inflator is present in a high temperature environment, such as in a vehicle fire.

When an inflator containing pressurized fluid is actuated, the inflation fluid flows out of the chamber through the exit opening. As a result of the inflation fluid flow through the exit opening, the inflator is subjected to a thrust. If there is only a single exit opening or if there are multiple exit openings oriented in generally the same direction, the thrust from the inflation fluid flow tends to move the inflator in a direction opposite to the direction of inflation fluid flow out of the chamber.

Inflators are often manufactured in one location and are assembled into a vehicle safety system at a different location. As a result, the inflators must be shipped from the location of manufacture to the location of assembly. Since actuation of an inflator results in a thrust being applied to the inflator, accidental actuation of an inflator may result in the inflator acting as a projectile. As a result, inflators are generally given a shipping classification as potentially hazardous items.

To reduce potential shipping hazards and thereby obtain a more desirable shipping classification, inflators with uni-directional exit openings may be fitted with shipping caps. A shipping cap attaches to an inflator and provides the inflator with thrust neutrality. Thrust neutrality means that the container of the inflator is not moved, or remains relatively stationary, while the inflation fluid exits the inflator. To provide the inflator with thrust neutrality, the shipping cap directs the exiting inflation fluid in various directions so that a thrust creating by inflation fluid exiting in one direction is countered by a similar thrust created by inflation fluid exiting in another direction. The shipping cap must be attached securely to the inflator prior to shipping of the inflator and must be removed prior to assembly of the inflator into the vehicle safety system.

FIG. 6 illustrates a known alternative to the shipping cap. In FIG. 6, the inflator 300, which includes a burst disk 302, an initiator 304, an autoignition device 306, and a stored gas 308 under pressure, is attached to a flow fitting or diffuser 320. The flow fitting 320 includes opposite first and second ends 322 and 324, respectively. The first end 322 of the flow fitting 320 is fixed to the inflator 300. An elongated chamber 330 extends into the flow fitting 320 from the first end 322 and terminates near the second end 324. A plurality of radially extending flow passages 334 extend outwardly from the chamber 330 at a location near the second end 324 of the flow fitting 320. The plurality of radially extending flow passages 334 are arranged to provide thrust neutrality to the assembly of the inflator 300 and the flow fitting 320.

The flow fitting 320 remains attached to the inflator 300 when assembled in a vehicle safety system, a portion of which is shown at 340. The second end 324 of the flow fitting 320 is inserted into a conduit 342 of the vehicle safety system 340. The conduit 342 directs inflation fluid to the inflatable vehicle occupant protection device. As FIG. 6 illustrates, inflation fluid flowing out of the radially extending flow passages 334 of the flow fitting 320 is directed against the wall of the conduit 342 and must flow through an annular passage 344 between the conduit and the flow fitting 320. As a result, the flow of inflation fluid from the flow fitting 320 into the conduit 342 may be restricted.

An apparatus that provides thrust neutrality and that reduces restrictions on the flow of the inflation fluid would be desirable.

### SUMMARY OF THE INVENTION

The present invention relates to an apparatus comprising an inflator that is actuatable for providing inflation fluid. First structure that is associated with the inflator includes a plurality of first flow passages that are sized and positioned relative to one another so as to provide thrust neutrality to the apparatus when inflation fluid exits the apparatus through the first flow passages in a first condition of the inflator. Second structure is associated with the inflator. The second structure blocks fluid flow through the first flow passages and provides fluid flow through a second passage in a second condition of the inflator.

According to another aspect, the present invention relates to an apparatus comprising an inflator that is actuatable for providing inflation fluid and a fluid flow control device for attachment to the inflator. The fluid flow control device includes a chamber for receiving the inflation fluid provided by the inflator. A plurality of first flow passages are connected to the chamber and are sized and positioned relative to one another so as to provide thrust neutrality to the apparatus when inflation fluid exits the fluid flow control device through the first flow passages. A second flow passage is connected to the chamber and is closed by a rupturable member. Inflation fluid ruptures the rupturable member and exits the fluid flow control device through the second flow passage only when the first flow passages are obstructed.

According to yet another aspect, the present invention relates to a vehicle safety system for helping to protect an occupant of a vehicle. The vehicle safety system comprises an inflator that is actuatable for providing inflation fluid and a fluid flow control device for attachment to the inflator. The fluid flow control device includes a chamber for receiving the inflation fluid provided by the inflator. A plurality of first flow passages are connected to the chamber and are sized and positioned relative to one another so as to provide thrust neutrality to the apparatus when inflation fluid exits the fluid flow control device through the first flow passages. A second flow passage is connected to the chamber and is closed by a rupturable member. Inflation fluid ruptures the rupturable member and exits the fluid flow control device through the second flow passage only when the first flow passages are obstructed. The vehicle safety system also comprises an inflatable vehicle occupant protection device that is connectable with the fluid flow control device and, in response to receiving inflation fluid from the fluid flow control device, inflates from a deflated condition to an inflated condition. The first flow passages of the fluid flow control device are unobstructed prior to connection of the inflatable vehicle occupant protection device with the fluid flow control device and are obstructed when the inflatable vehicle occupant protection device is connected with the fluid flow control device.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a vehicle safety system including an apparatus constructed in accordance with the present invention;

FIG. 2 is an enlarged view of a portion of the apparatus of FIG. 1;

FIG. 3 is an enlarged view of a portion of the apparatus of FIG. 1 assembled in the vehicle safety system;

FIG. 4 is an enlarged view of a portion of the apparatus of FIG. 1 assembled in the vehicle safety system and in an actuated condition;

FIG. 5 is a graph illustrating the gas pressures at various locations in the apparatus during various inflator deployment conditions; and

FIG. 6 illustrates a prior art inflator and associated flow fitting for providing thrust neutrality.

### DETAILED DESCRIPTION OF THE INVENTION

FIG. 1 illustrates a vehicle safety system 10 including an apparatus 12 constructed in accordance with one embodiment of the present invention. The apparatus 12 of the present invention is for use in inflating an inflatable vehicle occupant protection device of the vehicle safety system 10. The inflatable vehicle occupant protection device of FIG. 1 is an inflatable curtain 14. Alternatively, the inflatable vehicle occupant protection device may include an inflatable air bag, an inflatable seat belt, an inflatable knee bolster, an inflatable headliner, or a knee bolster operated by an inflatable air bag.

The inflatable curtain 14 of FIG. 1 is in a deflated condition and is stored within a housing 16. The inflatable curtain 14, in the deflated condition, and the housing 16 have an elongated configuration and are mounted to a vehicle 18 in a location adjacent both the side structure of the vehicle and a roof 20 of the vehicle. The side structure of the vehicle 18 includes an A-pillar 22, a B-pillar 24, a C-pillar 26, and side windows 28 and 30. FIG. 1 shows four brackets 32 securing the housing 16 and the inflatable curtain 14 to the side structure of the vehicle 18.

In the assembled vehicle safety system, a fill tube 34 connects the apparatus 12 of the present invention to the inflatable curtain 14. The apparatus 12 is in fluid communication with the inflatable curtain 14 through the fill tube 34. Upon actuation of the apparatus 12, inflation fluid flows through the fill tube 34 and into the inflatable curtain 14. In response to receiving the inflation fluid, the inflatable curtain 14 deploys from the deflated condition within the housing 16 to an inflated condition to cover portions of the side structure of the vehicle, such as the side windows 28 and 30.

The vehicle safety system 10 also includes a sensor 36 for sensing a deployment condition for which inflation of the inflatable curtain 14 is desired. The sensor 36 forms a portion of the electronic circuitry 38 of the vehicle safety system 10. When the sensor 36 senses a deployment condition for which inflation of the inflatable curtain 14 is desired, the electronic circuitry 38 of the vehicle safety system 10 actuates the apparatus 12 to provide inflation fluid to the inflatable curtain 14.

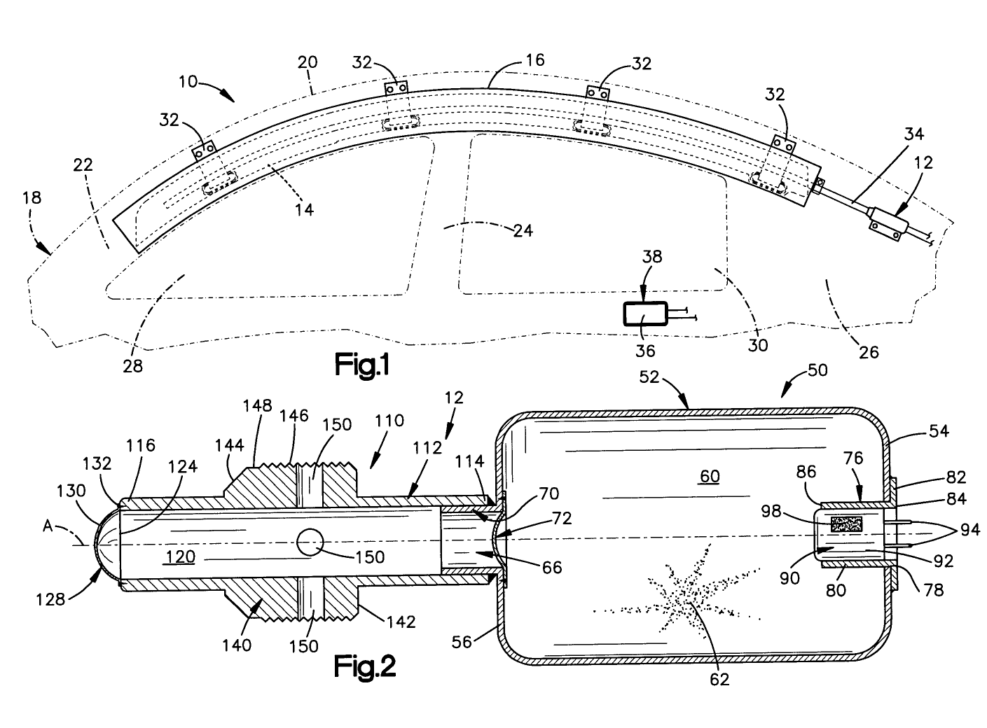

FIG. 2 is an enlarged cross-sectional view of the apparatus 12 of FIG. 1. The apparatus 12 includes an inflator 50. The inflator 50 includes a container 52 having opposite first and second ends 54 and 56, respectively, spaced apart along a central axis A. The container 52 includes a chamber 60 in which is stored a fluid 62 under pressure. The fluid 62 under pressure may be an inert gas, a combination of inert gases, or may be a combustible mixture of gases. As an alternative, the inflator 50 may include a stored gas and an ignitable material that, upon being ignited, heats the stored gas. As a further alternative, the inflator 50 could include a combustible gas generating material that, upon being ignited, produces inflation fluid.

A tubular mouth 70 of the container 52 extends outwardly from the second end 56 of the container along the axis A and defines a fluid flow passage 66. A rupturable burst disk 72 closes the fluid flow passage 66.

An initiator retainer 76 extends axially through an opening 78 in the first end 54 of the container 52. The initiator retainer 76 includes a tubular portion 80 and a flange portion 82. The tubular portion 80 includes opposite first and second ends 84 and 86, respectively. The flange portion 82 extends radially outwardly of the first end 84 of the tubular portion 80 and is fixed to the first end 54 of the container 52.

The initiator retainer 76 supports an actuatable initiator 90. The initiator 90 includes a body portion 92 that includes a pyrotechnic material (not shown) and a resistive wire (not shown). The resistive wire is connected to leads 94 of the initiator 90. The resistive wire is responsive to an actuation signal from the electronic circuitry 38 of the vehicle safety system 10 for actuating the initiator 90. The initiator 90 also includes an autoignition device 98 that is responsive to a high temperature environment for causing actuation of the initiator. Alternatively, the autoignition device 98 could be located elsewhere in the inflator 50.

The burst disk 72 ruptures in response to actuation of the initiator 90. When the fluid 62 stored under pressure in the chamber 60 is one or more inert gases, a shock wave produced by actuation of the initiator 90 ruptures the burst disk 72. When the fluid 62 stored in the chamber 60 includes a combustible mixture of gases or when the inflator 50 includes an ignitable material, actuation of the initiator 90 increases the pressure within the chamber 60. The resulting pressure differential across the burst disk 72 causes the burst disk to rupture.

When the burst disk 72 ruptures, as is shown in FIG. 4, a flow opening 100 extends through the ruptured burst disk 72 and connects the chamber 60 with fluid flow passage 66. Inflation fluid flows through the flow opening 100 and into the fluid flow passage 66 to exit the inflator 50.

The apparatus 12 also includes a fluid flow control device 110. The fluid flow control device 110 includes a generally tubular main body portion 112 that includes axially opposite first and second ends 114 and 116, respectively. A chamber 120 extends axially through the main body portion 112 between the first and second ends 114 and 116. A first circular opening to the chamber 120 is located at the first end 114 of the main body portion 112. A second circular opening 124 to the chamber 120 is located at the second end 116 of the main body portion 112.

A rupturable burst disk 128 closes the second circular opening 124. The burst disk 128 includes a domed central portion 130 and an annular flange portion 132 that extends radially outwardly of the domed central portion. The burst disk 128 is designed to rupture when subjected to a predetermined pressure differential across the domed central portion 130. As an alternative to the burst disk 128 that is attached to the second end 116 of the fluid flow control device 110, the main body portion 112 of the fluid flow control device 110 may includes an integral, thin walled portion that is designed to rupture when subjected to a predetermined pressure differential.

The main body portion 112 of the fluid flow control device 110 also includes a centrally located annular boss 140. The boss 140 includes a radially outwardly extending first end surface 142 and a tapered second end surface 144. An axially extending threaded surface 146 connects the first and second end surfaces 142 and 144. An annular surface 148 (FIG. 2) is interposed between the second end surface 144 and the axially extending threaded surface 146.

A plurality of flow passages 150 extends radially outwardly from the chamber 120 through the boss 140 of the main body portion 112 of the fluid flow control device 110. The fluid flow control device 110 of FIG. 2 includes four flow passages 150. Three of the flow passages 150 are shown in FIG. 2. The flow passages 150 are sized and arranged relative to one another so that when inflation fluid flows through the passages 150, the apparatus 12 is thrust neutral, i.e., remains relatively stationary as a result of the offsetting thrusts provided by the inflation fluid exiting through the passages 150. In the embodiment of the fluid flow control device 110 illustrated in FIG. 2, the flow passages 150 have the same cross-sectional area and are arranged in an annular array with the center of each flow passage 150 being spaced from the center of each adjacent flow passage by ninety degrees, when measured about the central axis A.

The first end 114 of the fluid flow control device 110 is fixedly attached to the tubular mouth 70 of the inflator 50. Inflation fluid flowing out of the inflator 50 through fluid flow passage 66 flows into the chamber 120 of the fluid flow control device 110.

Prior to being assembled in the vehicle safety system 10, for example, during shipping, the apparatus 12 of the present invention is in the condition shown in FIG. 2. In the event of autoignition of the inflator 50, inflation fluid exiting the inflator 50 will enter the chamber 120 of the fluid flow control device 110 and will exit the chamber 120 through the flow passages 150. Since the flow passages 150 are sized and arranged so as to provide the apparatus 12 with thrust neutrality, the apparatus 12 will remain relatively stationary as a result of the autoignition of the inflator 50.

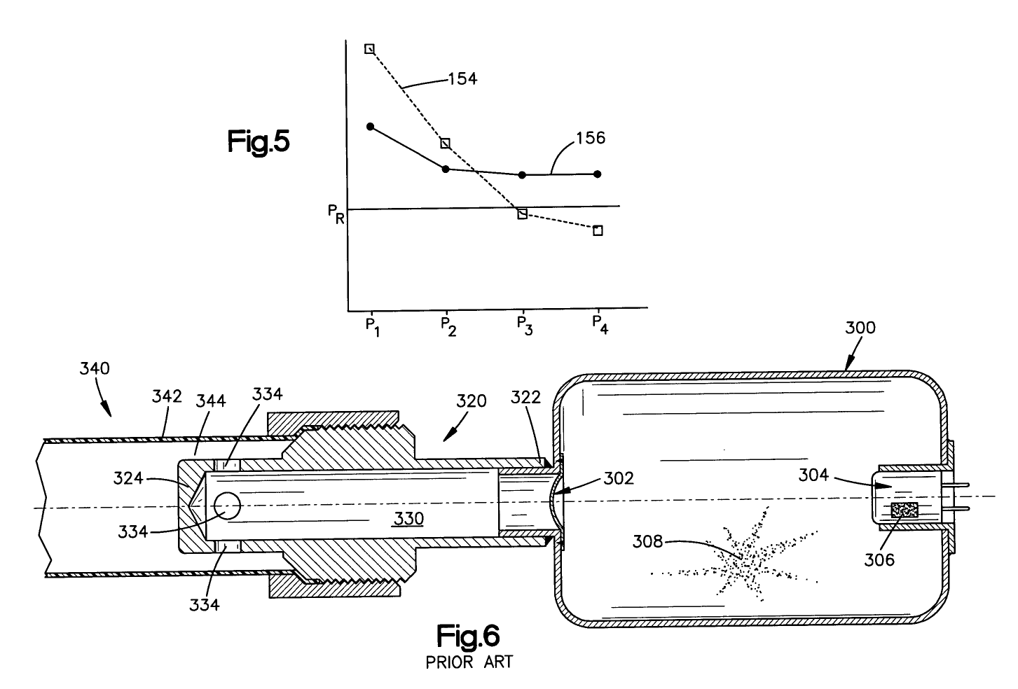

FIG. 5 graphically illustrates the pressure of the inflation fluid at various locations in the apparatus 12 shortly after actuation of the inflator 50. In FIG. 5, P₁ represents the pressure of the inflation fluid within the chamber 60 of the inflator. P₂ represents the pressure of the inflation fluid at a location adjacent the opening at the first end 114 of the fluid flow control device 110. P₃ represents the pressure of the inflation fluid at a location within the chamber 120 of the fluid flow control device 110 adjacent the flow passages 150 and along the central axis A. P₄ represents the pressure of the inflation fluid at a location within the chamber 120 of the fluid flow control device 110 adjacent the burst disk 128 and PR represents the pressure required to rupture the burst disk.

Line 154 of FIG. 5 illustrates the pressures resulting from autoignition of the inflator 50 when the apparatus 12 is separated from the vehicle safety system 10, as is shown in FIG. 2. As line 154 of FIG. 5 illustrates, the pressure adjacent the burst disk 128, i.e., P₄, remains below the pressure required to rupture the burst disk 128, i.e., PR. As a result, the burst disk 128 remains intact and all of the inflation fluid is directed out of the fluid flow control device 110 through the flow passages 150. Thus, the apparatus 12 is thrust neutral.

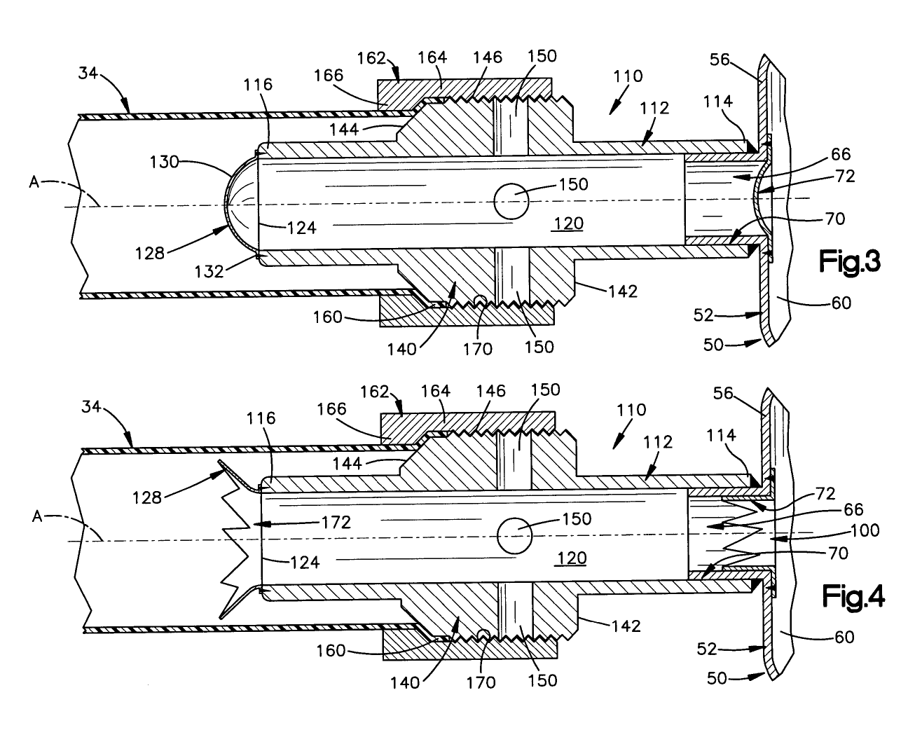

FIG. 3 shows the apparatus 12 assembled in the vehicle safety system 10. When assembled in the vehicle safety system 10, the second end 116 of the fluid flow control device 110 is inserted into the fill tube 34. An end 160 of the fill tube 34 is expanded and is seated on the second end surface 144 of the boss 140. When seated on the second end surface 144 of the boss 140, the fill tube 34 extends generally along the axis A and is generally coaxial relative to the fluid flow control device 110.

A nut 162 of the apparatus 10 extends around the end 160 of the fill tube 34. The nut 162 includes a cylindrical portion 164 and a radially inwardly extending portion 166. The cylindrical portion 164 includes a threaded inner surface 170 that is sized for meshingly engaging the axially extending threaded surface 146 of the boss 140 of the fluid flow control device 110. When the nut 162 is screwed onto the boss 140 of the fluid flow control device 110, the end 160 of the fill tube 34 is clamped between the nut 162 and the second end surface 144 of the boss 140. Additionally, when the nut 162 is screwed onto the boss 140 of the fluid flow control device 110, the cylindrical portion 164 of the nut 162 closes the flow passages 150 of the fluid flow control device 110.

When the apparatus 12 is assembled in the vehicle safety system 10, as is shown in FIG. 3, actuation of to the inflator 50, either by the electronic circuitry 38 of the vehicle safety system 10 or by the autoignition device 98, results in inflation fluid flowing out of the inflator 50 and into the chamber 120 of the fluid flow control device 110. Since the cylindrical portion 164 of the nut 162 closes the flow passages 150, the inflation fluid pressure in the chamber 120 increases. When the pressure within the chamber 120 adjacent the burst disk 128 increases above the pressure require for rupturing the burst disk, i.e., PR, the domed central portion 130 of the burst disk 128 is ruptured, as is shown in FIG. 4. When the burst disk 128 is ruptured, a fluid flow passage 172 extends through the ruptured burst disk 128. The fluid flow passage 172 is located downstream, relative to the inflator 50, of the flow passages 150. Inflation fluid exits the chamber 120 of the fluid flow control device 110 through the flow passage 172 and enters the fill tube 34. Thus, as is shown in FIG. 4, the inflation fluid flow out of the chamber 120 of the fluid flow control device 110 in the direction of elongation of the fill tube 34.

Line 156 of FIG. 5 illustrates the pressures resulting from actuation of the inflator 50 by the electronic circuitry 38 of the vehicle safety system 10 when the apparatus 12 is assembled in the vehicle safety system 10. As FIG. 5 illustrates, the pressure adjacent the burst disk 128, i.e., P₄, is greater than the pressure required to rupture the burst disk 128, i.e., P_{R}. As a result, the burst disk 128 is ruptured and the flow passage 172 is formed.

With reference to FIG. 5, it is noted that the pressures with the chamber 60 of the inflator 50, i.e., location P1, and adjacent the opening at the first end 114 of the fluid flow control device 110, i.e., location P2, are higher when the inflator 50 is actuated by the autoignition device 98 (line 154) than when actuated by the electronic circuitry 38 of the vehicle safety system 10 (line 156). This increased pressure occurs in response to the increased temperature of the inflator 50 that results in the actuation of the autoignition device 98.

From the above description of the invention, those skilled in the art will perceive improvements, changes and modifications. Such improvements, changes and modifications within the skill of the art are intended to be covered by the appended claims.

Having described the invention, we claim the following:

1. An apparatus comprising:
an inflator that is actuatable for providing inflation fluid; and
first structure associated with the inflator including a plurality of first flow passages that are sized and positioned relative to one another so as to provide thrust neutrality to the apparatus when inflation fluid exits the apparatus through the first flow passages in a first condition of the inflator; and
second structure associated with the inflator, the second structure blocking fluid flow through the first flow passages and providing fluid flow through a second passage in a second condition of the inflator.

2. The apparatus of claim 1 wherein the first structure includes a fluid flow control device that receives inflation fluid exiting the inflator and the first condition of the inflator is prior to assembly in a vehicle safety system.

3. The apparatus of claim 2 wherein the second structure comprises a nut that connects the fluid flow control device to the vehicle safety system and the second condition is assembled in the vehicle safety system.

4. An apparatus comprising:
an inflator that is actuatable for providing inflation fluid; and
a fluid flow control device for attachment to the inflator, the fluid flow control device including a chamber for receiving the inflation fluid provided by the inflator, a plurality of first flow passages connected to the chamber and being sized and positioned relative to one another so as to provide thrust neutrality to the apparatus when inflation fluid exits the fluid flow control device through the first flow passages, a second flow passage connected to the chamber and being closed by a rupturable member, inflation fluid rupturing the rupturable member and exiting the fluid flow control device through the second flow passage only when the first flow passages are obstructed.

5. The apparatus of claim 4 wherein the second flow passage is located downstream relative to the inflator from the first flow passages.

6. The apparatus of claim 4 wherein the first flow passages are arranged in an array extending radially outwardly through the fluid flow control device.

7. The apparatus of claim 6 wherein the second flow passage is axially spaced from the first flow passages and extends axially through an end of the fluid flow control device.

8. The apparatus of claim 4 wherein the inflator includes an autoignition mechanism for actuating the inflator to provide inflation fluid when the inflator is present in a high temperature environment.

9. The apparatus of claim 4 wherein the fluid flow control device includes structure for connecting the apparatus with an inflatable vehicle occupant protection device, the first flow passages being located relative to the structure so as to become obstructed when the fluid flow control device is connected to the inflatable vehicle occupant protection device.

10. The apparatus of claim 9 wherein the structure of the fluid flow control device includes a threaded outer surface for connecting the fluid flow control device with the inflatable vehicle occupant protection device, the first flow passages extending between the chamber and the threaded outer surface.

11. A vehicle safety system for helping to protect an occupant of a vehicle, the vehicle safety system comprising:
an inflator that is actuatable for providing inflation fluid;
a fluid flow control device for attachment to the inflator, the fluid flow control device including a chamber for receiving the inflation fluid provided by the inflator, a plurality of first flow passages connected to the chamber and being sized and positioned relative to one another so as to provide thrust neutrality to the apparatus when inflation fluid exits the fluid flow control device through the first flow passages, a second flow passage connected to the chamber and being closed by a rupturable member, inflation fluid rupturing the rupturable member and exiting the fluid flow control device through the second flow passage only when the first flow passages are obstructed; and
an inflatable vehicle occupant protection device connectable with the fluid flow control device and, in response to receiving inflation fluid from the fluid flow control device, inflating from a deflated condition to an inflated condition,
the first flow passages of the fluid flow control device being unobstructed prior to connection of the inflatable vehicle occupant protection device with the fluid flow control device and being obstructed when the inflatable vehicle occupant protection device is connected with the fluid flow control device.

12. The vehicle safety system of claim 11 wherein the second flow passage of the fluid flow control device is located downstream relative to the inflator from the first flow passages.

13. The vehicle safety system of claim 11 wherein the fluid flow control device includes a threaded outer surface for connecting the fluid flow control device with the vehicle occupant protection device, the first flow passages extending between the chamber and the threaded outer surface.

14. The vehicle safety system of claim 13 wherein a fill tube connects the fluid flow control device with the vehicle occupant protection device, a nut being associated with the fill tube for attaching the fill tube to the fluid flow control device, the nut when attaching the fill tube to the fluid flow control device obstructing the first flow passages of the fluid flow control device.

15. The vehicle safety system of claim 14 wherein the fill tube, when connected to the fluid flow control device, extends in a first direction relative to the fluid flow control device, inflation fluid exiting the chamber through the second flow passage flowing in the first direction.
